(19) United States
(12) Patent Application Publication
(10) Pub. No.: US 2025/0369709 A1
(43) Pub. Date: Dec. 4, 2025

(54) EVAPORTATION SYSTEMS INCLUDING ELECTROPLATED HEAT EXCHANGERS AND METHODS FOR MANUFACTURING THE SAME

(71) Applicant: Circle Verde Water Corporation, Bardstown, KY (US)

(72) Inventors: Joseph V. Alexander, Lexington, KY (US); John A. Mayer, Bardstown, KY (US); Bobby L. Gaffney, Glasgow, KY (US); James C. Hayden, Bardstown, KY (US); Charles E. Mayer, Bardstown, KY (US)

(21) Appl. No.: 19/226,483

(22) Filed: Jun. 3, 2025

Related U.S. Application Data
(60) Provisional application No. 63/655,296, filed on Jun. 3, 2024.

(51) Int. Cl. F28F 19/06; F16N 1/00; F28F 19/00

(52) U.S. Cl. CPC F28F 19/06; F16N 1/00; F28F 19/008; F28F 2255/00

(57) ABSTRACT

Described herein are processes that allow fluids that contain residual components such as oils, grease, and/or solids, and which are prone to the formation of scale, fouling, or corrosion, to be partially or fully evaporated. In some embodiments, the technology described herein relates to the development of an evaporator that contains a heat exchange surface that is plated with a corrosion and wear resistant metal. The evaporator assembly may also contain a mechanical scraper or wiper to continuously remove fouling, oil, grease, or other buildup that may otherwise inhibit heat exchange.

### CROSS-REFERENCE TO RELATED APPLICATIONS

The present application claims benefit for priority to U.S. Provisional Patent Application No. 63/655,296, entitled “EVAPORTATION SYSTEMS INCLUDING ELECTROPLATED HEAT EXCHANGERS AND METHODS FOR MANUFACTURING THE SAME LEARNING OUTPUT” and filed on Jun. 3, 2024, which is specifically incorporated by reference herein for all that it discloses and teaches.

### BACKGROUND

A considerable challenge concerning processes to evaporate liquids that are caustic, corrosive, oily, and or greasy is the proneness of these liquids to form layers of fouling, scale or other thermally non-conductive materials on the surfaces of heat exchangers. The formation of these fouling or scale layers greatly inhibits heat transfer and therefore diminishes the processing capacity of these evaporation units.

Fouling layers may be formed from the deposition of residual components such as oil, grease, particulate, or salts that were either present prior to the liquids' entry into the evaporator or these fouling layers were formed by the precipitation of solids or materials by the evaporation process. Additionally, a caustic environment may cause a layer of thermally non-conductive material to be formed from the reaction of the exterior surface of the heat exchanger with the caustic solution.

Many corrosion resistant materials have been used in evaporation equipment, however many of these corrosion resistant materials possess less favorable heat transfer characteristics than materials less resistant to corrosion.

Accordingly, a need continues to exist for improved equipment (e.g., heat exchangers) that does not suffer from or at least minimize the previously described issues.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

Described herein are processes that allow fluids that contain residual components such as oils, grease, and solids, and which are prone to the formation of scale, fouling or corrosion, to be partially or fully evaporated. Additionally, the processes described herein allow materials that have desirable heat exchange characteristics to be employed.

The technology described herein concerns the development of an evaporator that contains a heat exchange surface that is plated with a corrosion and wear resistant metal. This evaporator assembly also contains a mechanical scraper or wiper to continuously remove fouling, oil, grease or other residual buildup that would inhibit heat exchange.

The heat exchanger portion of this evaporator may be formed by electroplating a layer of metal onto the surface(s) of the heat exchanger that would be in contact with the evaporating liquid. In some embodiments, the inner surface of a tubular heat exchanger is coated with a corrosion and wear resistant metal using electroplating.

The electroplating process described herein involves filling all or a portion of a tubular heat exchanger with a suitable electroplating solution. An anode containing the metal to be deposited is centrally suspended within the heat exchanger's tube. A current is then passed across this anode and the tube's surface causing the desired metal to be deposited onto the surface of the tube.

The plated tube may then be fabricated in such a manner that a mechanical scraper or wiper assembly is installed within the tube. This scraper may be powered by a motor, gear or some other form of supplying mechanical power. The plated tube may be surrounded by a source of thermal heat to allow the water or other fluid to be evaporated efficiently.

In order to prevent the scrapers or wipers from sticking or their motion from being inhibited, an oil or other lubricant may be introduced into the fluid entering the evaporator. After the fluid leaves the evaporator, the oil or lubricant may be recovered by using a phase separator. This lubricant may be continuously recirculated through the evaporator.

In order to prevent seizure and otherwise ensure acceptable performance, one or more the sliding surfaces used to position and move the scrapers or wipers may be continuously or intermittently supplied with oil, grease or other lubricant. This action has the further benefit of inhibiting corrosion and preventing egress of particulate and liquid materials into an area between sliding surfaces, preventing excess wear and seizure.

Materials suitable for the scraper materials may typically be somewhat corrosion resistant and, in some embodiments, should be less hard than the material used to plate the interior of the heat exchanger tube.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a schematic illustration of a system for electroplating the interior surface of a tubular element, the system being configured in accordance with various embodiments described herein.

FIG. 2 is a schematic illustration of a system for electropolishing the interior surface of a tubular element, the system being configured in accordance with various embodiments described herein.

FIG. 3 is a cross sectional view of a scraped tube heat exchanger incorporating a plated interior surface configured in accordance with various embodiments described herein.

FIG. 4 is a cross sectional view of a phase separator attached to a scraped tube heat exchanger according to various embodiments described herein.

FIG. 5 is a schematic illustration of a system for recirculating lubricant within an evaporation processing employing a scraped tube heat exchanger configured in accordance with various embodiments described herein.

FIG. 6 is a schematic illustration of a containerized, modular, heat exchanger apparatus configured in accordance with various embodiments described herein.

FIG. 7 is a schematic illustration of a modular heat exchanger with an integral crane configured in accordance with various embodiments described herein.

FIG. 8 is a schematic illustration of a heat exchanger with integral crane configured in accordance with various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the technology described herein. However, embodiments may be implemented in many different forms and should not be construed as being limited to the embodiments set forth herein. The following detailed description is, therefore, not to be taken in a limiting sense.

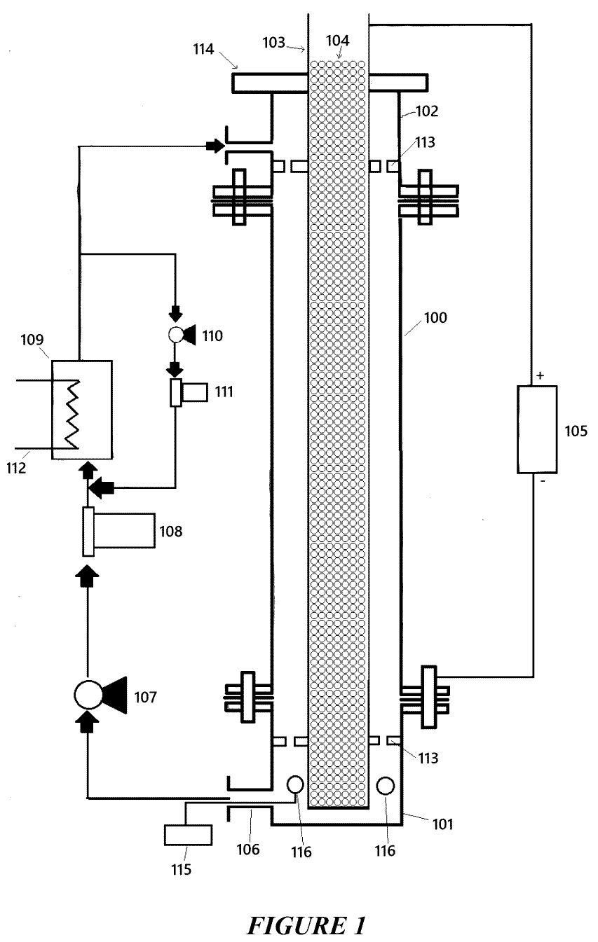

With respect to FIG. 1, a system for forming a scraped heat exchanger tube is shown. The tube 100 has a lower manifold 101 and an upper manifold 102 attached to opposing ends of the tube 100. The purpose of the upper and lower manifolds 101, 102 is to allow the interior surface of the heat exchanger tube 100 to be completely immersed in a plating solution.

A basket 103 containing the metal to be plated 104 is centrally positioned within the tube 100 such that the basket 103 preferably spans a significant portion (e.g., greater than 50%, 60%, 70%, 80%, or 90%) or the entire length of the tube 100. The plating metal is generally not limited. In some embodiments, the plating metal is selected such that the plated metal is harder than a wiper or scraper used to wipe or scrape the inner surface of the heat exchanger plated with the metal.

A direct current rectifier 105 is established to pass direct current in such a manner that the plating basket 103 acts as an anode and the inner wall of the tube 100 acts as a cathode.

The plating solution may be withdrawn from the tube 100 through a port 106 on the lower manifold 101 whereby the solution is pumped 107 through one or more filters 108. The plating solution may be stored in a reservoir 109. Within this reservoir 109, a portion of the plating solution may be pumped 110 through filters 111 to continuously clean the plating solution. The solution may be heated or cooled during this process through heating and/or cooling coils 112.

The plating solution may be reintroduced into the upper manifold 102, whereby the plating solution is continuously recirculated through the tube 100 being plated that will become a component of a scraped tube heat exchanger.

The central positioning of the plating basket 103 may be ensured using spacers 113 that prevent that basket 103 from moving too close to the wall of the tube 100.

A dust cover 114 may be positioned over the top of the tube 100 to prevent contamination of the plating solution.

An air pump 115 may be used to inject compressed air at or near the bottom of the tube 100 to ensure rapid mixing of the plating solution and to prevent gas bubble buildup. This compressed air may be introduced into the bottom of the plating solution contained within the tube 100 using notched or holed tube or pipe 116.

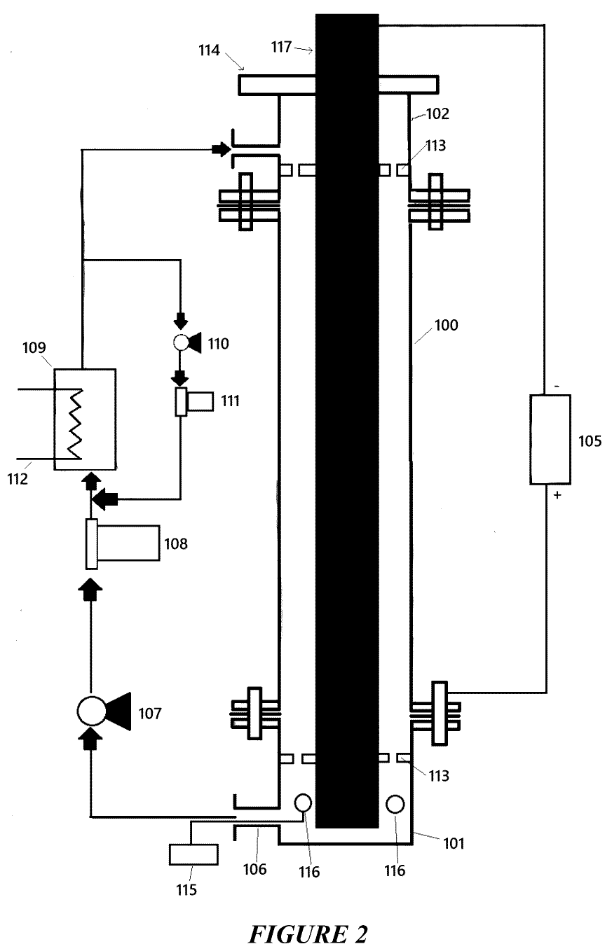

FIG. 2 illustrates a system for electropolishing the interior surface of a tube 100 that may be used during fabrication a scraped tube heat exchanger. This electropolishing may be performed after the deposition of a metal layer on the interior surface of the tube using electroplating as described in greater detail above with respect to FIG. 1.

Within the tube 100, a metal cathode 117 is centrally positioned in such a manner that it extends through some portion or the complete length of the tube 100. Upper 102 and lower 101 manifolds are positioned at opposite ends of the tube 100 to allow an electropolishing solution to be circulated through the length of the tube 100 in such a manner as to submerge all surfaces to be polished.

A rectifier 105 passes direct electrical current between the centrally located cathode 117 and the tube 100 being electropolished in such a manner as to ensure the tube 100 acts as the anode. In some embodiments, the material of the scraper or wiper included within the tube may act as a sacrificial anode during the plating.

The electropolishing solution may be recirculated by removing a portion of the solution from a port 106 in the lower manifold 101, pumping 107 the solution through one or more filters 111 and potentially storing the solution in a reservoir 109 where the solution may be heated or cooled 112. Within this reservoir 109, the solution may be recirculated through filters 111 or other absorbent containing vessels.

From the reservoir 109, the electropolishing solution may be reintroduced at the upper 102 manifold.

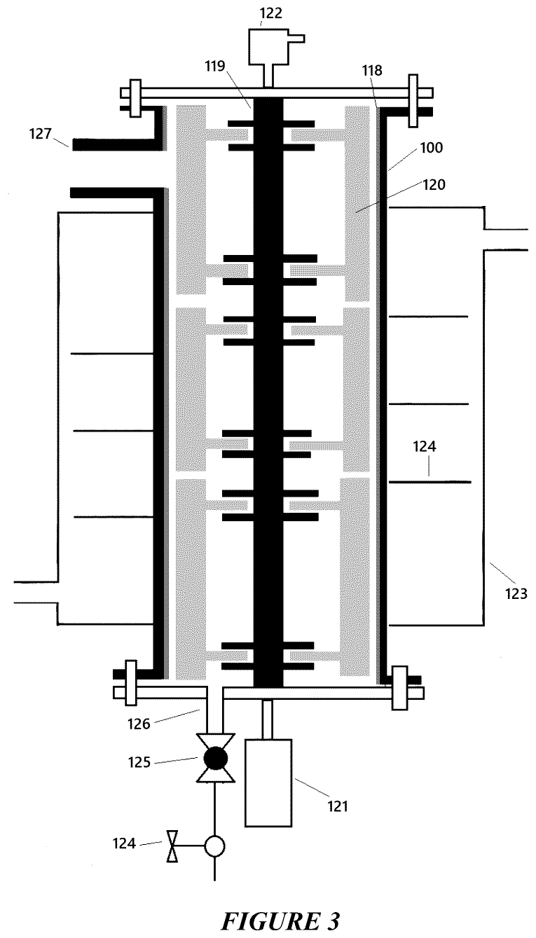

FIG. 3 provides a cross-section view of a scraped tube heat exchanger incorporating a tube having an electroplated surface. A metal tube 100, with its interior surface coated/plated by a corrosion or wear resistant metal 118 has a rotating axle 119 with wiping blades 120 positioned in its center. These blades 120 and axle 119 are rotated by a motor 121. A rotation sensor 122 may be positioned at the opposite end of the scraped tube heat exchanger than the motor 121.

A jacket 123 may surround the exterior surface of the scraped tube 100, allowing a gas or other liquid to transfer heat to the scraped tube 100. Baffles 124 may be positioned within the jacket 123 to ensure adequate mixing and distribution of the gas or liquid within the jacket 123 and to mechanically support the scraped tube 100.

Fluid may enter the scraped tube heat exchanger assembly through a tube 126, the flow of which is measured by a flowmeter 125 and regulated by a valve 124. The heated, cooled, or evaporated fluid leaves the scraped tube heat exchanger through a port (not shown) on the opposite end of the scraped tube heat exchanger as the inlet port.

In operation, the scrapers/wipers may be used to continuously or intermittently wipe one or more heat exchange surfaces, including a plated heat exchanger surface. In some embodiments, the inner surface of the plated tube of the heat exchanger is continuously wiped with one or more scrapers that are powered by the central axle (i.e., shaft).

In some embodiments, the heat exchanger is used in a process wherein water is evaporated within the heat exchanger. The water being evaporated within the heat exchanger may include residual components, such as grease, oil, and/or solids. This residual material may become affixed to the plated surface of the heat exchanger during and/or as a result of water evaporation. In order to prevent this material from becoming affixed to the plated surface and/or remove material that has already become affixed to the plated surface, the action of the scrapers/wipes is used to remove the residual material from the plated surfaces. In so doing, the efficiency of heat exchange through the tube is not deteriorated via build up of residual components on the plated surfaces.

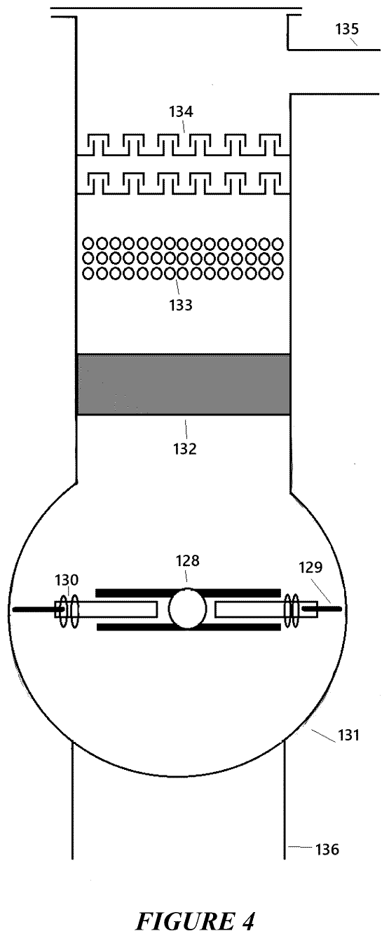

FIG. 4 illustrates a system for separating vapor from liquids and solids formed using a scraped tube exchanger. A scraper assembly is rotated by a central shaft 128, the wiper/scrapers 129 being powered by this shaft 128. A spring and piston apparatus 130 may be used to ensure the blades 129 remain pressed against the wall 131 of the heat exchanger.

Steam and/or other vapors exit the scraped tube apparatus and are first filtered by a mesh pad 132 to prevent further ingress of particles or solids. One or more layers of packing 133 and/or distillation trays 134 may be used to increase the separation performance of the evaporation system and increase the purity of the vapor stream prior to this stream exiting through a port 135.

Liquids and solids exit the assembly under the influence of gravity through a port located at the bottom of the assembly 136.

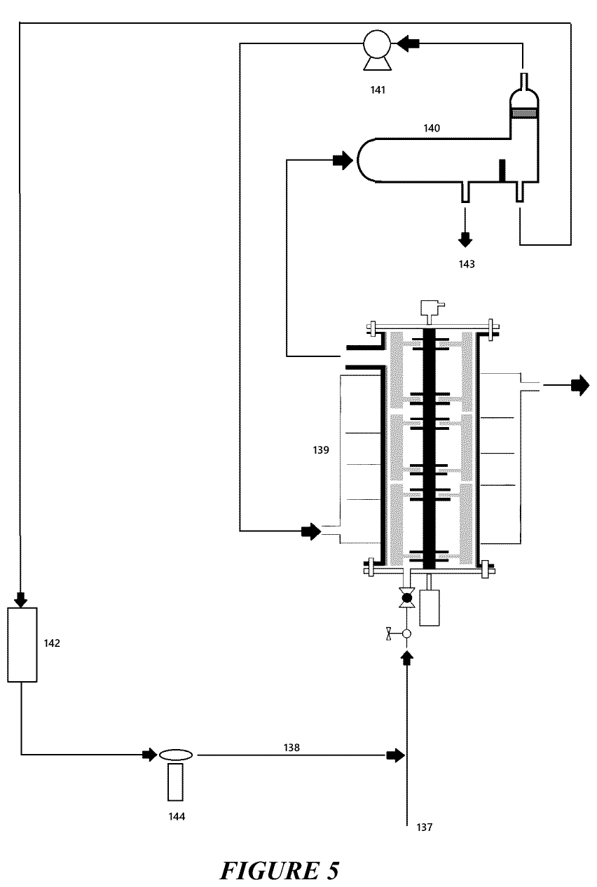

FIG. 5 illustrates a system for continuously providing lubrication to a scraped tube heat exchanger apparatus while recovering and recycling the lubricant.

Fluid to be evaporated or processed enters the heat exchanger 139 through a port 137, prior to which a lubricant 138 may be added via the same port 137. Steam, vapor, liquids and solids then leave the heat exchanger apparatus 139, whereby it is sent through a phase separator 140.

Within the phase separator 140, vapor is separated and may be filtered, then directed to a compressor or blower 141. The lubricant is separated from the liquids and may be directed towards a reservoir 142. The remaining liquid exits through a port 143.

A metering pump 144 may be used to inject the recovered lubricant into the stream prior to entering the heat exchanger assembly.

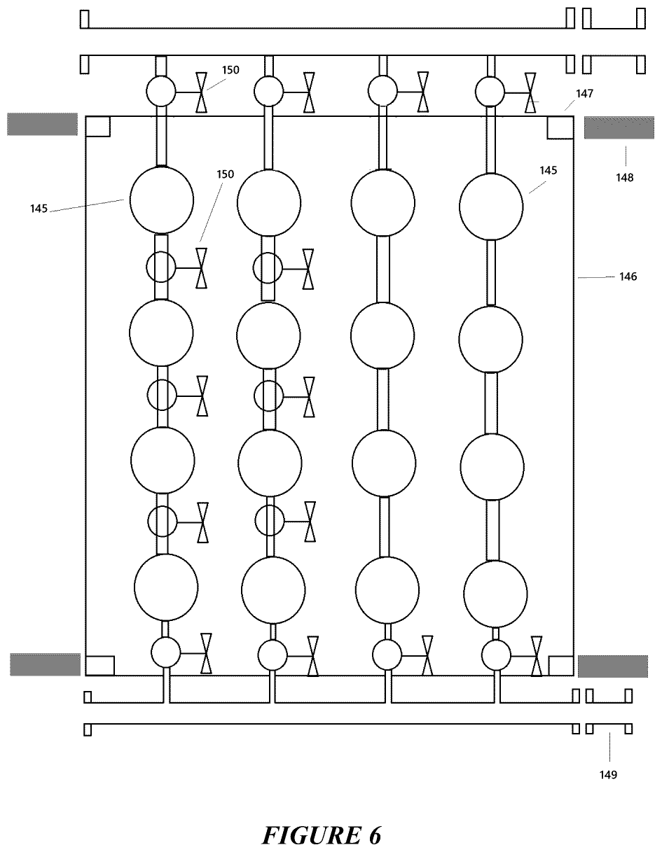

FIG. 6 shows a modularized scraped tube heat exchanger assembly. Tubes 145 that contain scrapers as previously described are arranged within a central shaft that rotates blades that wipe or scrape the inner surfaces of the tubes 145. These tubes 145 are positioned within a container 146 through which a fluid or gas stream is introduced to heat or cool the contents of the tube 145.

At the corner of the module are located connection points 147, which are capable of connecting to each other, potentially through a connector 148. This allows heat exchanger modules to be connected to one another in parallel.

Modules connected in such a way, may have their fluid passage streams connected with each other through connectors 149 that may be flexible.

Individual heat exchanger tubes 145 may be isolated in groups or individually through the use of valves 150.

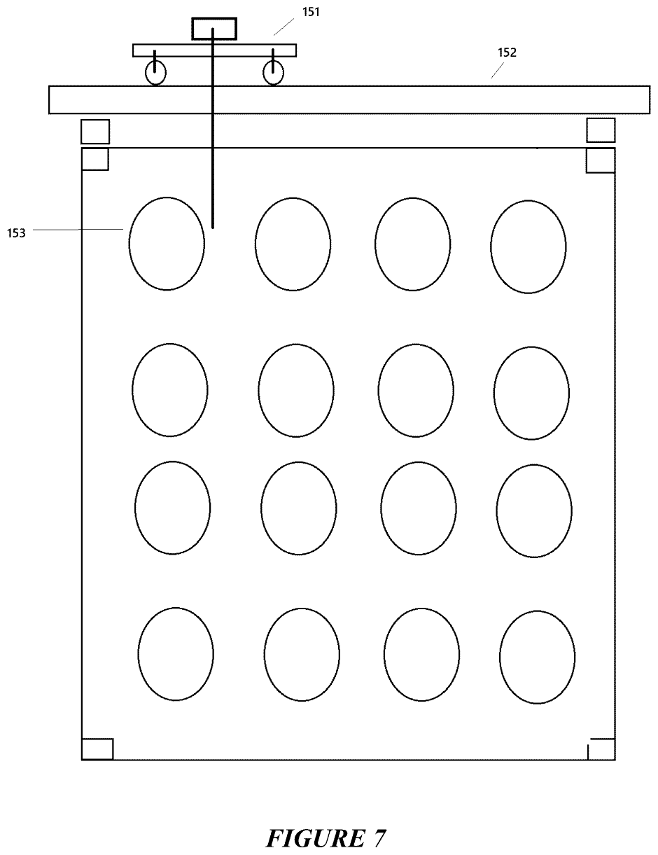

FIG. 7 shows a system including an integrally mounted crane to assist on a modularized heat exchanger. Crane 151 is mounted on a rail system 152, which is mounted on the upper surface of the modularized heat exchanger. This rail system 152 allows the crane 151 to move between heat exchanger tubes 153 and even between heat exchanger modules.

The crane system 151 may be used to ease the removal, replacement and replacement of axle assemblies within each of the heat exchanger tubes 153.

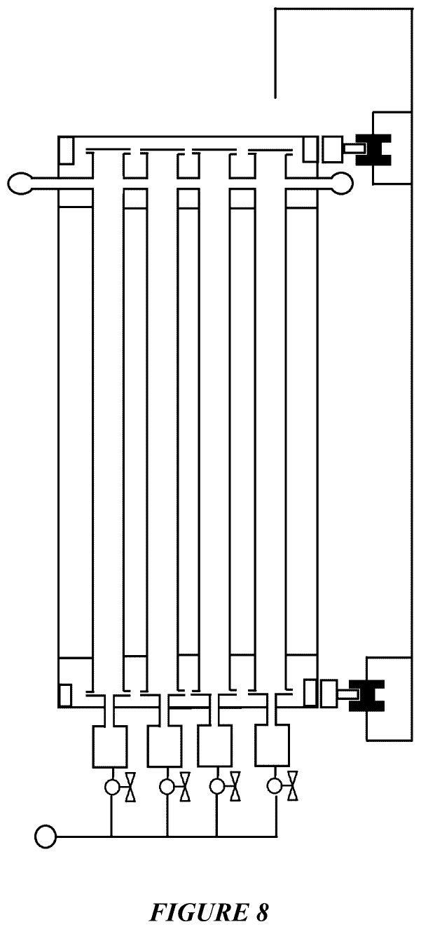

FIG. 8 illustrates a method of mounting a crane system onto heat exchanger modules to assist with maintenance, repair and replacement or scraper assemblies.

The specific type of heat exchanger used in the technology described herein is generally not limited. In some embodiments, the heat exchanger is a concentric tube, and an inner surface of the tube is plated. In some embodiments, the heat exchanger is a shell and tube type heat exchanger, and an inner surface of the tube is plated.

From the foregoing, it will be appreciated that specific embodiments of the technology have been described herein for purposes of illustration, but that various modifications may be made without deviating from the scope of the technology. Accordingly, the technology is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/we claim:

1. A method of heating, cooling, evaporating and/or condensing fluids, comprising:
plating one or more heat exchange surfaces of a heat exchanger with a metal; and
continuously or intermittently wiping the one or more heat exchange surfaces using a scraper or wiper.

2. The method of claim 1 wherein plating the one or more heat exchange surfaces comprises using an electroplating process.

3. The method of claim 1 wherein the heat exchanger is a concentric tube, and an inner surface of the concentric tube is plated.

4. The method of claim 1 wherein the heat exchanger is a shell and tube type heat exchanger, and an inner surface of the tube is plated.

5. The method of claim 4 wherein the one or more heat exchange surfaces comprises an inner surface of a tube component of a heat exchanger, and continuously or intermittently wiping the one or more heat exchange surfaces using a scraper or wiper comprises wiping the inner surface of the tube component of the heat exchanger continuously with one or more scrapers that are powered by a central shaft.

6. The method of claim 1, further comprising:
evaporating water within the heat exchanger; and
removing residual components from the one or more heat exchange surfaces by the action of the wipers or scrapers.

7. The method of claim 1 wherein the material of the scraper or wiper acts as a sacrificial anode during the plating.

8. The method of claim 1, further comprising:
electropolishing one or more of the plated heat exchange surfaces.

9. The method of claim 1, wherein the scrapers or wipers are mounted to a centrally positioned axle, thereby allowing the scrapers or wipers to be rotated within the heat exchanger.

10. The method of claim 9, wherein couplings are attached to the ends of the axle, thereby allowing rapid assembly and disassembly of the axle and scraper or wiper.

11. A method of heating, cooling, evaporating and/or condensing fluids, comprising:
providing a scraped or wiped heat exchanger; and
introducing a lubricating agent into the fluid to be processed by the heat exchanger.

12. The method of 11, further comprising:
recovering the lubricant after the fluid leaves the heat exchanger.

13. The method of claim 12, further comprising:
reintroducing recovered lubricant into the heat exchanger.

14. The method of claim 11, wherein an inner surface of the heat exchanger has a metal plated thereon, and the plated metal is harder than a wiper or scraper used to wipe or scrape the inner surface of the heat exchanger.

15. The method of claim 1, wherein the plated metal on the heat exchange surface is harder than the material of the scraper or wiper.
